(19) United States
(12) Patent Application Publication
(10) Pub. No.: US 2014/0372242 A1
(43) Pub. Date: Dec. 18, 2014

(54) SYSTEM AND METHOD OF SHARING OWNERSHIP OF AND AUTHORIZING ACCESS TO DIGITAL MEDIA

(71) Applicant: Garrett O'Beirne, Islip, NY (US)

(72) Inventor: Garrett O'Beirne, Islip, NY (US)

(21) Appl. No.: 14/307,636

(22) Filed: Jun. 18, 2014

Related U.S. Application Data
(60) Provisional application No. 61/836,265, filed on Jun. 18, 2013.
(60) Provisional application No. 61/841,622, filed on Jul. 1, 2013.

(51) Int. Cl. G06Q 30/06

(52) U.S. Cl. CPC G06Q 30/0605
USPC 705/26.2

(57) ABSTRACT

A method of sharing and managing ownership of and access to digital media works includes initially offering for sale a predetermined number of blocks of a digital media work, for example, a song, each block representing a share of ownership of the song. Access is provided to a user to use the digital media work, for example, to listen to the song, via a link provided after purchasing a block of the song. The selling price of the blocks is updated based on a demand for the digital media work. For example, the selling price can be increased in incremental amounts in proportion to a percentage of the number of blocks sold until the entire initial stash of blocks is sold. Thereafter, blocks can be sold to, and traded between, users in various gaming and other applications that promote social aspects of the method, as well as for profit.

### CROSS-REFERENCE TO RELATED APPLICATIONS

This application claims the benefit of and priority to U.S. Provisional Application Ser. No. 61/836,265, entitled “SYSTEM AND METHOD OF SHARING OWNERSHIP OF AND AUTHORIZING ACCESS TO DIGITAL MEDIA,” filed Jun. 18, 2013, and U.S. Provisional Application Ser. No. 61/841,622, entitled “S′Y′STEM AND METHOD OF SHARING OWNERSHIP OF AND AUTHORIZING ACCESS TO DIGITAL MEDIA,” filed Jul. 1, 2013, the entirety of each of which is hereby incorporated herein by reference thereto.

### FIELD OF THE DISCLOSURE

The present disclosure relates to ownership of and access rights to digital media, in particular, to a system and method for sharing and exchanging digital media.

### BACKGROUND

ITUNES® services is a popular known media player and media library application developed by Apple Inc. This web-based service can be used to play, download, and organize digital audio and video on personal computers and on various other known devices adapted for media storage and play.

Through an on-line ITUNES® Store, users can purchase and download music, music videos, television shows, games, audiobooks, podcasts, movies, movie rentals, and ringtones, generally for use on one device or computer. However, the ability to transfer media, for example, music, from one portable device to another is not available. Similarly, music and other digital media is not available for sharing between multiple users. Accordingly, ITUNES® provides a central distribution center and website from which digital media can be purchased for single-user, or single household, use.

Initiated primarily as a way to encourage consumers to legally purchase music online, another service, “Popcuts,” operated a website from about 2008 to 2010 that offered songs for download for 99 cents each. Upon purchase, a user obtained store credit. Thereafter, when others purchased the same song, the earlier purchaser(s) were granted additional credits, which could eventually be redeemed for more music available on Popcuts. Popcuts reportedly retained 10 or 20 percent of the sales, the artists determined the percentage they wished to keep and still maintained full rights to distribute their works through other platforms, and the remaining percentage of proceeds were distributed among the fans who purchased the music.

Accordingly, in this distribution model, the less popular the song is, the more the consumers essentially pay for it. Conversely, the more popular the song is, the less the consumers pay for it.

Another recent product known as TastemakerX, is a gaming application, recently available as an app, which allows players to make “trades” on bands and artists based on who the players deem to be “trending” or rising stars. If they are correct, they are awarded points. The number of points earned by a player is a measure of the player's success as a music influencer.

Accordingly, TastemakerX is a game that tracks trends in artists and bands and does not relate to ownership of or investment in, songs or any other creative works.

Currently, there is no known product, method, or system that allows users to invest in, own shares in, and trade a limited number of real shares of ownership in digital media.

### SUMMARY

Features of the disclosure will become apparent from the following detailed description considered in conjunction with the accompanying drawings. It is to be understood, however, that the drawings are designed as an illustration only and not as a definition of the limits of this disclosure.

The present disclosure is directed to a method of sharing and managing ownership of and access to digital media works. The method includes: offering for sale in an initial offering, by a processing device, a predetermined number of blocks of a digital media work, each block representing a share of ownership of the digital media work; providing access, by the processing device, to a user to use the digital media work in response to the user purchasing at least one of the predetermined number of blocks; and updating, by the processing device, a selling price of the predetermined number of blocks based on a demand for the digital media work.

In one aspect, updating the selling price of the predetermined number of blocks includes increasing the selling price of the predetermined number of blocks remaining for sale in incremental amounts in proportion to a percentage of the predetermined number of blocks sold.

In a further aspect, the method further includes providing the user access, by the processing device, to a plurality of users for offering for sale at least one of the predetermined blocks purchased by the user to the plurality of users, in response to the predetermined number of blocks being sold out in the initial offering.

In an additional aspect, providing access includes providing access to the user to use the digital media via a link.

In yet another aspect, the method includes preventing the user from reproducing or downloading the digital media.

In still another aspect, updating the selling price includes increasing, by the processing device, the selling price in proportion to an increase in the frequency of sales of the predetermined number of blocks.

The present disclosure is also directed to a system of sharing and managing ownership of and access to digital media works. The system includes a processing device, and a storage device for storing instructions that, when executed by the processing device, perform operations including: offering for sale in an initial offering a predetermined number of blocks of a digital media work, each block representing a share of ownership of the digital media work; providing access to a user to use the digital media work in response to the user purchasing at least one of the predetermined number of blocks; and updating a selling price of the predetermined number of blocks based on a demand for the digital media work.

In one aspect, the operation for updating the selling price includes increasing the selling price of the predetermined number of blocks remaining for sale in incremental amounts in proportion to a percentage of the predetermined number of blocks sold.

In another aspect, the operations further include providing the user access to a plurality of users for offering for sale at least one of the predetermined blocks purchased by the user to the plurality of users, in response to the predetermined number of blocks being sold out in the initial offering.

In yet another aspect, the operation for providing access includes providing access to the user via a link to use the digital media.

In still another aspect, the operations further include blocking the user from reproducing or downloading the digital media.

In a further aspect, the operation for updating the selling price includes increasing the selling price in proportion to an increase in the frequency of sales of the predetermined number of blocks.

The present disclosure is also directed to a computer readable device storing instructions that, when executed by a processing device, perform operations including: offering for sale in an initial offering a predetermined number of blocks of a digital media work, each block representing a share of ownership of the digital media work; providing access to a user to use the digital media work in response to the user purchasing at least one of the predetermined number of blocks; and updating a selling price of the predetermined number of blocks based on a demand for the digital media work.

In one aspect, the operations for updating the selling price include increasing the selling price of the predetermined number of blocks remaining for sale in incremental amounts in proportion to a percentage of the predetermined number of blocks sold.

In another aspect, the operations further include providing the user access to a plurality of users for offering for sale at least one of the predetermined blocks purchased by the user to the plurality of users, in response to the predetermined number of blocks being sold out in the initial offering.

In yet another aspect, the operations for providing access include providing access to the user via a link to use the digital media, the operations further including at least one of blocking the user from reproducing the digital media and blocking the user from downloading the digital media.

In a further aspect, the operation for updating the selling price includes increasing the selling price in proportion to an increase in the frequency of sales of the predetermined number of blocks.

In various aspects, the digital media work includes one or more of an audio work, a song, a video clip, a movie, an artwork, a photograph, a literary work, e.g., a book, and a gaming application.

In addition to the above aspects of the present disclosure, additional aspects, objects, features and advantages will be apparent from the embodiments presented in the following description and in connection with the accompanying drawings.

### BRIEF DESCRIPTION OF THE DRAWINGS

The drawings constitute a part of this disclosure and include examples, which may be implemented in various forms. It is to be understood that in some instances, various aspects of the disclosure may be shown exaggerated or enlarged to facilitate understanding. The teaching of the disclosure can be readily understood by considering the following detailed description in conjunction with the accompanying drawings.

FIG. 1A is a flow diagram representation of an embodiment of a method of the present disclosure.

FIG. 1B is a flow diagram representation of an embodiment of a method of the present disclosure.

FIG. 2 is a graphic representation of a predetermined number of blocks of a digital media work offered for sale in an initial offering and block purchased in the initial offering in accordance with an embodiment of the method of the present disclosure.

FIG. 3 is a schematic representation of an embodiment of a system for implementing various embodiments of the methods of the present disclosure.

### DETAILED DESCRIPTION

The following sections describe particular embodiments. It should be apparent to those skilled in the art that the described embodiments provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present method and system as defined herein and equivalents thereto.

Throughout the description, where items are described as having, including, or comprising one or more specific components, or where methods are described as having, including, or comprising one or more specific steps, it is contemplated that, additionally, there are items of the present disclosure that consist essentially of, or consist of, the one or more recited components, and that there are methods according to the present disclosure that consist essentially of, or consist of, the one or more recited processing steps.

It should also be understood that the order of steps or order for performing certain actions is immaterial, as long as the method remains operable. Moreover, two or more steps or actions may be conducted simultaneously or concurrently.

Furthermore, various embodiments may be described herein in terms of functional block components, code listings, optional selections, page displays, and various processing steps. It should be appreciated that such functional blocks may be realized by any number of hardware and/or software components configured to perform the specified functions. For example, the present disclosure my employ various integrated circuit components, e.g., memory elements, processing elements, logic elements, look-up tables, and the like, which may carry out a varies of functions under the control of one or more microprocessors or other control devices.

Similarly, the software elements of the present disclosure may be implemented with any programming or scripting language such as C, C-+C#, Java, COBOL, assembler, PERL, Python; PHP, or the like, with the various algorithms being implemented with any combination of data structures, objects, processes, routines or other programming elements. The object code created may be executed by any device having a data connection capable of connecting to the Internet, on a variety of operating systems including without limitation Apple OSX® Apple iOS®, Google Android®, HP WebOS®, linux, UNIX®, Microsoft Windows®, and/or Microsoft Windows Mobile®.

It should be appreciated that the particular embodiments described herein are illustrative of the disclosure and its best mode, if known, and are not intended to otherwise limit the scope of the present disclosure in any way. Examples are presented herein which may include sample data items which are intended as examples and are not to be construed as limiting. For the sake of brevity, conventional data networking, application development and other functional aspects of the systems (and components of the individual operating components of the systems) may not be described in detail herein.

As should be appreciated by one of ordinary skill in the art, many alternative or additional functional relationships or physical or virtual connections may be present in a practical electronic system or apparatus. In the discussion contained herein, the terms user interface element, button, and tab, are understood to be non-limiting, and include other user interface elements such as, without limitation, a hyperlink, clickable image, and the like.

The present disclosure may be embodied as a method, a data processing system, a device for data processing, or a computer program product. The methods and method steps may be implemented via a programming application (sometimes referred to as an “app”) installed on a mobile device such as a smart phone or tablet, or a service, e.g., a programming application installed on a server system and hosted on a server device, which is accessible, for example, via a website from a computer or smart device.

In various embodiments, the present disclosure may take the form of an entirely software embodiment, an entirely hardware embodiment, or an embodiment combining aspects of both software and hardware. Furthermore, the present disclosure may take the form of a computer program product on a computer-readable storage medium having computer-readable program code means embodied in the storage medium. Any suitable computer-readable storage medium may be utilized, including hard disks, CD-ROM, DVD-ROM, optical storage devices, magnetic storage devices, semiconductor storage devices (e.g., flash memory, USB thumb drives) and/or the like.

Computer program instructions embodying the present disclosure may also be stored in a computer-readable memory that can direct a computer or other programmable data processing apparatus to function in a particular manner, such that the instructions stored in the computer-readable memory produce an article of manufacture, including instruction means, that implement the function specified in the description and/or flowchart block(s). The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the present disclosure.

One skilled in the art will also appreciate that any databases, systems, or components of the present disclosure may consist of any combination of databases or components at a single location or at multiple locations. Furthermore, each database or system includes any of various suitable security features, such as firewalls, access codes, encryption, de-encryption, compression, decompression, and/or the like.

The disclosed systems and/or methods may be embodied, at least in part, in application software that may be downloaded, in whole or in part, from either a website or an application store (“app store”) to the mobile device. In another embodiment, the disclosed system and method may be included in the mobile device firmware, hardware, and/or software.

In yet other embodiments, all or part of the disclosed systems and/or methods and/or steps may be provided as one or more callable modules, an application programming interface (e.g., an API), a source library, an object library, a plug-in or snap-in, a dynamic link library (e.g., DLL), or any software architecture capable of providing the functionality disclosed herein.

The present disclosure relates to a system and method for sharing digital media works, allowing users to buy creative works in digital format, and also to share them, exchange them, and actually earn a profit off of them. The method includes treating the digital media in a similar way as shares of stocks, with the shares rising and decreasing in value from people buying and selling them. Instead of shares, in the present method and system, the user can buy “blocks” of a digital media work.

A “block” as used herein, refers to a share of ownership in a particular digital media work. For example, in the embodiments described herein, a block refers to a share of ownership, and is also essentially a trading piece for ownership of the digital media work. Ownership of a block also entitles the owner to rights to use the digital media work, which can be provided, for example, via a website link, preferably associated with the block, through which users can, for example, depending on the type of media, and without limitation: stream an audio digital work, video, or gaming application; read a published work; view artwork recorded in digital form; and so on.

In some embodiments, ownership of the block does not allow the owner to download or copy the digital media work. In some additional embodiments, the link to the digital media associated with the purchased block can be added to a library of the user's blocks in accordance with the system and method of the present disclosure. In still further embodiments, the link can be accessed on any of the purchaser's internet-enabled or mobile devices via a website or app.

“Demand” as referred to herein refers to a desire of the user community, for example, the Song STAX community, to possess ownership in a particular digital media work, and can be quantified by one or more indicators.

An “exchange floor” as used herein refers to a graphical user interface, or a landing page, available via a website or app, from which users can view all of the blocks offered for sale and/or trade by all other users, and implement such trades and/or sales in accordance with the system and methods of the present disclosure.

The term “landing page” is used herein to refer to any web page, page, or screen, including those viewable from an app, and encompasses a home page, as well as any page that can be accessed via a link or tab from a home page or any other page.

In various embodiments, a website and/or app (a programming application installed on a mobile device) is provided to facilitate users' access to the digital media ownership sharing and trading system. The features of one embodiment of a system and method of the present disclosure for sharing and trading songs, which is accessible via a website or app, are described herein. Preferably, the system and method include providing an initial public offering or initial sale of a predetermined number of blocks of songs to the public, and providing an exchange floor for trading the blocks. In various embodiments, in addition to access to the exchange floor, users can also have access to one or more of a block store, a block library, block management tools, a discover center, a gaming center, and social link from a website referred to herein as the Song STAX website. As described further below, each of these features may be organized and available on a landing page, which may be accessible, fur example, via an appropriately labelled tab or link on a website page or app interface.

“STAX” is an acronym for Sharing Trading and Xchange. While the system and method of the present disclosure are described in more detail herein in terms of an embodiment of a system of digital song ownership and sharing, referred to herein as “Song STAX,” it is understood that the present system and method can also be extended to any digital creation or media, including, but not limited to, movies, books, music, artwork, and gaming applications. It should also be understood that “ownership” as referred to herein refers to a percentage of ownership as it pertains to use of the particular digital media within, for example, the Song STAX system, and not to shares of profits that may be attached to the digital media work outside the Song STAX environment.

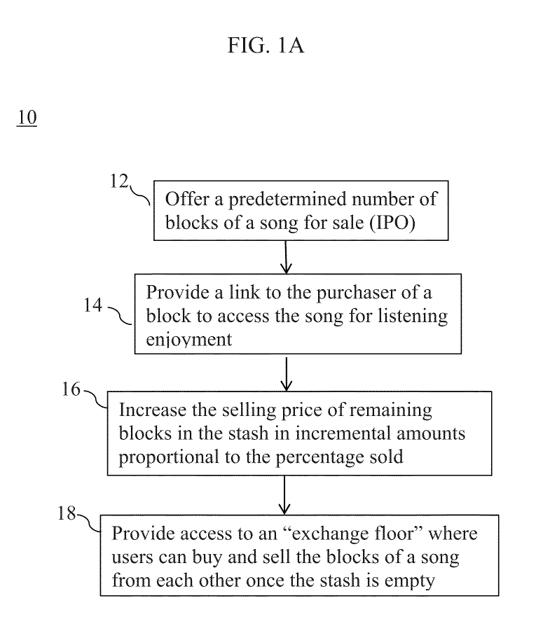

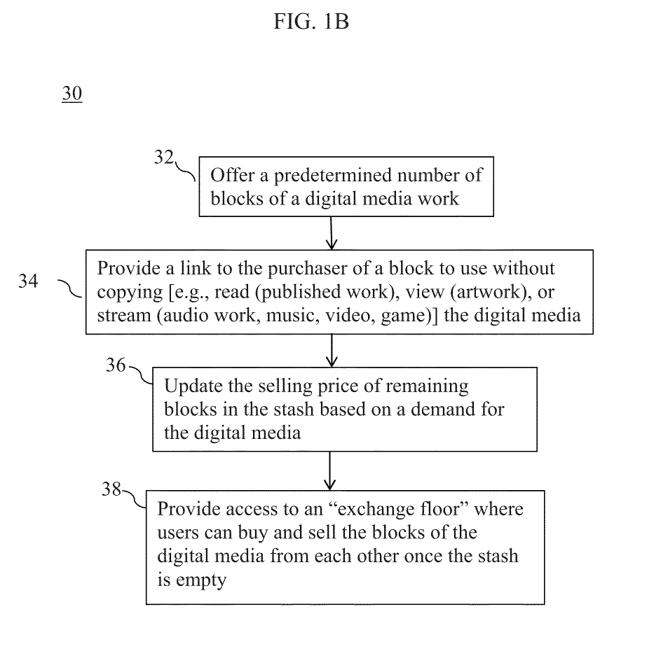

Referring to FIG. 1A, in one embodiment 10, a predetermined number of blocks of ownership of a digital song are offered for sale via a website or app 12, referred to herein as the Song STAX site. In some embodiments, the user has the option to listen to at least a portion of the song before purchasing a block. Upon purchasing a block, the user is provided a link that allows the user access to listen to the song 14. In some embodiments, the link allows the user access to listen to the song for an unlimited number of times, for as long as the user retains ownership of the block.

In particular, when a song is first released, a certain number of starting blocks will be sold at an opening price depending on a projected value due, in an initial public offering (IPO). A number of variables can be considered to determine the song's starting price, such as, without limitation, current popularity of the artist, featured artists involved in the song, and quality of the song. If people enjoy the song or have confidence it will become popular, they will quickly buy blocks of the song as early as possible during the IPO both for enjoyment and potential profit. The Song STAX user can act as an investor, buying blocks with the expectation that others will later buy in at a higher price as the song's popularity increases; the more blocks that are sold, the higher the price per block of the song will become. the owner of the block(s) wants to make a profit, the owner sells the blocks at a higher price than his or her purchase price.

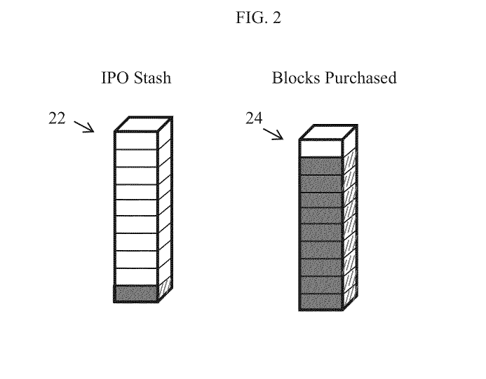

In one example, in an initial offering of a particular song, 100,000 blocks are offered for sale directly by the Song STAX system. This initial group of blocks that are offered for sale are referred to herein as the “stash.” Referring to the example of FIG. 2, a graphical representation can be available from the Song STAX website or app to buyers and potential buyers of blocks of the stash 22. As the blocks in the stash are sold, the stash empties and the number of blocks shown in the purchasers' column 24 increases, as shown with shading. In the example of FIG. 2, 10,000 blocks remain for sale in the stash, with 90,000 having been purchased. The IPO phase continues until all blocks in the stash are sold and the stash is empty.

When the stash is empty, the column 24 representing purchased blocks from the IPO is full. At this point, the blocks can be referred to as “full” blocks. At the conclusion of the IPO, full blocks can be resold and/or traded among the Song STAX users.

Incentives are preferably provided to motivate potential buyers as well as to further engage users once they have purchased blocks of one or more songs. In one embodiment, a selling price of the blocks remaining in the stash increases as demand increases, for example, in incremental amounts in proportion to a percentage of the initial blocks sold 16. For example, the first 10,000 blocks can be offered for sale at 10 cents each, then the next 10,000 can be offered for 20 cents, and so on until the last 10,000 blocks are offered for a dollar until the stash is empty. Accordingly, the earlier a user purchases, and/or before the demand is high, the cheaper the blocks can be purchased.

In various embodiments, a selling price of the blocks remaining in the stash can also increase or decrease in proportion to some other demand indicator, for example, in proportion to an increase and/or decrease in the frequency of purchases of the initial blocks, e.g., a time interval between consecutive purchases, or in proportion to an increase or decrease in the frequency of resales of the initial blocks back to the stash, or in simple proportion to the amount of time the blocks have been on sale.

In particular embodiments, the users of Song STAX essentially become micro-investors, with the demand created by the micro-investors, via social media, for example, driving the price of blocks of a particular song up, as supply moves down.

Referring to FIG. 1B, and as described herein, the system and method of the present invention can be applied to any one or more types of digital media work. For example, in one embodiment of a method 30 in accordance with the present disclosure, a predetermined number of blocks of a digital media work are offered 32. The method further includes providing a link to the purchaser of at least one block of the digital media work to use the work 34. For example, depending on the type of digital media, the link could provide access to play a gaming application, to read a published literary work, to view and/or modify an artwork, or to stream an audio or video work. The method then further includes updating a sales price of blocks of the digital media still remaining in the stash based on a demand, or demand indicator, for the media work.

Referring to FIG. 1A and FIG. 1B, once the corresponding stash is empty, some embodiments of the system and methods of the present disclosure also include providing each user access to a plurality of users via an “exchange floor” for offering for sale and/or trade with each other blocks of songs 18 or any type of digital media 38. Trades and/or sales among the users are preferably implemented from the exchange floor.

Referring again to the particular example referred to herein as Song STAX, a user can also sell the song back to the stash at any time before the stash is empty, preferably in a manner that increases the profit of both the system and the purchaser/seller. For example, Song STAX could provide an offer to purchase a block back from a purchaser at a price of 75% of the current value. Accordingly, if the user purchases one of the first 10,000 blocks at 10 cents, later, when the selling price of the block has risen to 30 cents during the IPO, the user can sell the block back to the stash at 22.5 cents. The user has made a profit of 12.5 cents and the system now has converted a 10 cent share to a minimum 30 cent share at a total cost of 10.5 cents, and can sell the block to another user at 30 cents or higher, essentially making more profit in the end for the artists and distributors who own the rights to the songs.

Of course, the purchaser of a block in the early stages of an IPO may also profit by holding on to the block until the stash is empty and then selling the full block to another user at a price greater than the highest IPO sales price.

It should be appreciated that the number of total blocks in the stash in the initial offering could be any reasonable preselected number. In certain cases, it may be preferable to offer a lower number of blocks, for example, 100, or a higher number of blocks, for example, 1,000,000.

Whether the initial number is 100 or 10,000 or any other number, in particular embodiments, once all of the blocks in the first stash are sold, none of the purchased blocks can be resold back to the stash.

In other embodiments, on the condition of a trigger event, none of the purchased blocks can be resold back to the stash. The trigger event can include, for example, a ratio of purchased blocks resold to the stash, to initial blocks sold exceeding a predetermined threshold. Alternatively, the trigger event can include, for example, a. frequency at which the purchased blocks are being resold to the stash exceeding a predetermined threshold.

Once the initial stash is empty, and all the blocks in the purchaser's column 24 are full, no purchased blocks can be resold back to the stash. If, for example, 100 blocks of a song are initially offered and are quickly sold, in a subsequent offering for another song, the predetermined number of blocks may be automatically increased to, for example, 1,000 blocks, in various embodiments, the number of predetermined blocks that are sold may be determined by the popularity of the artist, previous sales history for the artist and/or genre, and any other factors that may be used to gauge how many blocks should be sold in the initial public offering. As before, once the stash is empty and all of the blocks have been sold (and resold, if the stash has bought back blocks in the process), no purchased blocks can be resold back to the stash.

In some embodiments, a number of blocks that can be sold to a single user is limited to a predetermined number or a predetermined percentage of blocks in an offering.

Referring again to FIG. 1A, a user of the Song STAX system has access to an “exchange floor” where he or she can buy and sell the blocks from each other once the stash is empty 18, creating an earning possibility, as well as track the prices of all blocks. In one embodiment, once the stash is empty, the system generates a suggested selling price for sate to other users of the system based on the activity and popularity of the song. Such statistics can be gathered from various resources, including the distributers of the song and social media.

The exchange floor is provided via the Song STAX system as a platform for users to trade blocks once the stash is empty, primarily from an “exchange floor” tab or link, offered via the website or app. The exchange floor offers additional features as described below.

Additional tabs or links to various features, which can be provided on various landing pages, for example, can also be provided via the Song STAX website or app. For example, in some embodiments, the landing pages accessible to the user include, without limitation: a block store, a block library, block management tools, a discover center, a gaming page referred to herein as “my bundle,” and a friends page, as described further below. Although various features are described herein as grouped within a particular landing page, it is understood that the features/landing pages and method steps implemented therein can be combined or grouped in numerous ways, and are not limited to the particular groupings or headings described herein.

### Exchange Floor

In some embodiments of the system and methods in accordance with the present disclosure, trading services are available to the user via an exchange floor page. Services offered to the user include, without limitation: searching for a block of any song, viewing the sates prices of all available blocks, offering to buy blocks from other users, proposing trades to other users, tracking every block in the song STAX system, and so on in some embodiments, the exchange floor feature includes continuous, real-time information on trends including prices of blocks for sale, for example. Users can see trends, sales and exchanges in real-time. In certain embodiments, checks are also run on the operating conditions of the system to see if it is running correctly and the results of these checks are made available to the users.

Preferably, the exchange floor also includes a trading block where each user can offer blocks for sale and for trading with other blocks. Users can view other users' offers on the trading block to offer trades. In particular embodiments, searching tools are also provided so that in response to a user's search Dora song, every block on the trading block will be listed. The blocks offered for sale can further be ordered, for example, from lowest to highest offering price, for the user's convenience in purchasing blocks of interest.

### Block Store

In some embodiments, a block store tab or link and landing page is included for advertising featured songs and products. Different categories can be displayed and are available for selection by the users, such as, new releases, top rising blocks of songs, editor's picks, bargain buys, full blocks (i.e., blocks for resale after the initial stash is empty) available from other users, blocks still available from the stash, and so on. From the block store, users can buy blocks from either the stash, if still available, or from the Song STAX “bundle,” or from another user, for example, once the IPO stage has concluded, at the users' selling price. Preferably, the selling price of each block of a song is arranged in an order of increasing price, allowing the potential purchaser to easily locate the lowest possible price.

### Block Library

A block library is included in embodiments in accordance with the system and method of the present disclosure, which provides users an opportunity to view and play the songs of the blocks they own. They can also make playlists and enjoy the songs for personal use.

### Block Management

Various embodiments also include block management tools, which may be accessible via a block management page, for example, for users to manage and track blocks that they have purchased. For example, in various embodiments, users can view blocks they have purchased, track the value of the blocks, whether increasing or decreasing, and track how close the blocks of a particular song are to being full (how many are left in the stash). In a “my blocks” section of the management tab, for example, a chart can be generated showing how close every one of the user's blocks are to being full, what each of the block's value is, and other data related to the blocks.

In various embodiments, additional investment management functions are provided, including an option to chart how much the user is willing to sell blocks of various songs for, to track one's earnings and spending, and to otherwise manage one's blocks. For example, in a “my profile” section of the management tab, charts and data showing the user's purchases, sales, and earnings achieved can be generated.

### Discover Center

A feature can also be provided via a web page, for example, where users can find new artists that are lesser known that they can invest in. Preferably, a profile of each artist is provided, along with a link to at least one of the artist's songs, and, optionally, a video of the artist singing/performing and/or just introducing themselves. These features enhance the experience of the user in discovering artists and in engaging in the business of owning a record company. From the artist profile, a user can also purchase blocks of songs by the artist.

Additional enhancements are contemplated, including featuring different artists on the page from time to time (at random intervals) or at a predetermined interval (i.e., on a weekly or monthly basis).

### Friends

A “friends” page can also be provided from which a user can search for and add friends to Song STAX. Features that can be provided include a listing of all of the user's friends, links to their profiles and bundles, and a list of friends that have made the most profit that week, month, year and all time. Other searchable criteria are also contemplated.

### My Bundle

Additional embodiments in accordance with the system and methods of the present disclosure can include social media, sharing, and game-like aspects, in which a user's assets in Song STAX are displayed and organized for a particular visual and/or useful effect. In one embodiment, a user's blocks can appear as cubes. The cubes can be shown with a picture of the artist or the single artwork on it, but will only show the percentage of the block that is hill. For example, if the block is 30% full, only 30% of the image will be shown.

A user can arrange his or her blocks in any manner, and can make various designs or structures, to “bundle” blocks associated with the same and/or different songs in various informative or visually appealing formats. For example, one section of a “My Bundle” page featuring a user's bundle can include a playlist creation function, which allows a user to stack or order any of his or her blocks in a bundle or stack to create playlists.

When the user clicks on one of the blocks in the bundle or stack, the song associated with the block is streamed for the user's listening pleasure. Similarly, clicking on the stack will play the blocks in the assigned order.

In some embodiments, the user can also stream the songs associated with the purchased blocks via a programming application, or “app,” downloaded onto the user's mobile device.

The user can also choose to display how much the blocks were purchased for and how much they are currently worth. In one embodiment, users can share their stacks or single blocks with other users through social media, letting them view them and listen to their songs.

It is also contemplated to provide a social gaming feature on this page where friends can have a “Stack Off.” In this feature, users pick four of their blocks to make a stack and compete with each other to determine whose stack is better, as voted on by other friends on Song STAX, for example. Additionally, when viewing a friend's bundle or stack, a user can offer to buy their stacks of blocks, or any individual block, from them directly. Accordingly, a visual gaming aspect and a social media feel is provided in that users of the Song STAX system can share and exchange what they are listening to with friends.

### Other Features

In additional embodiments, users of the Song STAX system who own a block of a song are also provided the option to buy the song, preferably at a discount. This option can be provided via a link on any one or more of the pages of the Song STAX system for purchasing and downloading the song, which can then be stored in a user's customized Song STAX library or elsewhere. In another embodiment, a Song STAX subscriber who has purchased a block of the song can obtain a coupon, or redemption code, usable toward the purchase of the song.

In some embodiments, once all of the blocks in the stash are sold, a “streaming only” option is offered for sale by the system that includes use rights, but no ownership stake to sell or trade blocks.

### Business Model

The system and method of the present disclosure provide numerous advantageous to the artists and/or distributors. Of the initial blocks sold during the IPO, including any blocks sold back to the stash and resold, the artists and/or distributors preferably earn a substantial percentage of the profits. Once these initial blocks are sold out, and only the users are selling or trading them to each other, a small percentage, for example, 10%, of the total sale will be charged as an exchange fee. Of this exchange fee, the artist and/or distributor of the song will earn a significant percentage, the remaining staying with the operator of the system. In this way, the artists, the Song STAX company, and the users can all make significant profits, commensurate with the popularity of the songs.

Not only does the Song STAX system and method of the present disclosure provide financial benefits to users, distributers, artists, and other investors, it can also lead to higher quality songs becoming popular due to people investing money into them. Active users of the system invest in songs not just for listening pleasure, but also for bragging rights as owners, for profit, and for offering support to the artists using an open crowd-funded model.

Accordingly, from the initial public offering of a limited number of blocks, each song becomes a scarce resource and a collectible item. When songs become more popular, e.g., as more of the initial blocks are sold, their selling price and value increases. With the Song STAX system, average people, in addition to the corresponding artists and record labels, benefit from this increase in popularity and value.

Unlike any system and method, or app or website, currently known, users of embodiments of the current disclosure can effectively operate as their own personalized record label, not only by buying songs but also by investing in artists before they are well known, and profiting from their later popularity and success. In addition, the system and method of the present disclosure are structured to incentivize users to legally access and use digital songs and other digital media by providing both potential profits and a social gaming aspect to song ownership through Song STAX.

Although various aspects of the system and method have been described in reference to one embodiment as features available from particular links or tabs available through a website, it should be understood that such features and aspects can be arranged in any number of various ways, and not limited to a particular arrangement of tabs or links, for access via a website, link, or via an app downloaded on any mobile device, such as a smart phone, tablet and so on.

### Embodiment of a System for Implementing the Methods of the Present Disclosure

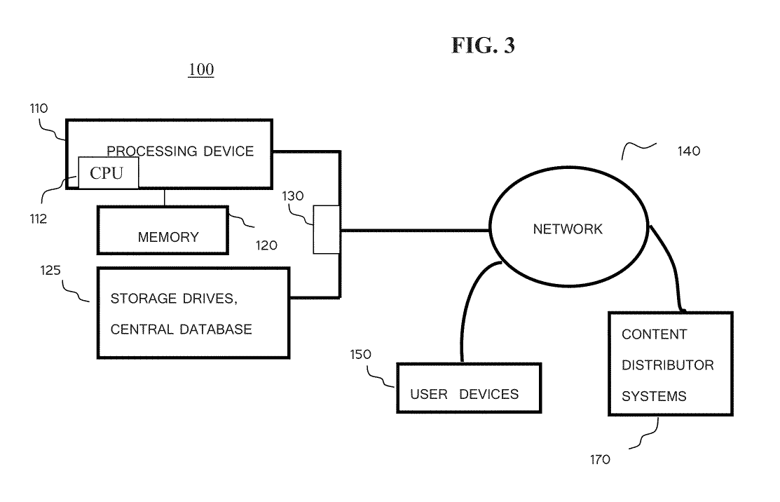

Referring to FIG. 3, the various embodiments of the methods of the present disclosure are implemented via computer software or executable instructions or code. FIG. 3 is a schematic representation of an embodiment of a system 100 for implementing the methods of the present disclosure. The system includes at least a processing device 110 including a Central Processing Unit (CPU) 112, memory 120, and storage device(s) 125 preferably including a central database for storing and updating user information and details associated with the management of users' ownership rights, access rights, exchange, and trading histories, and other information. The system 100 also includes interface hardware 130 for connecting to external systems 170, such as distributers of digital media, and for connecting with users of the system via any type of known network 140, such as the Internet.

The memory 120 includes computer readable memory accessible by the processing device 110 for storing instructions that when executed by the processing device 110 causes the processor to implement the steps of the methods described herein. The memory 120 can include transitory memory, non-transitory memory, random access memory (RAM), read only memory (ROM), a storage device including a hard drive, or a portable, removable computer readable medium, such as a compact disk (CD) or a flash memory, or a combination thereof. The computer executable instructions for implementing the methods of the present disclosure may be stored in any one type of memory associated with the system 100, or distributed among various types of memory devices provided, and the necessary portions loaded into RAM, for example, upon execution. As should be understood to those of skill in the art, computer executable instructions can also be downloaded to a user device 150, such as a personal computer, smart phone, or tablet in the form of an app, for example, for integrating with and/or implementing the methods of the present disclosure.

In one embodiment, a non-transitory computer readable product is provided, which includes a computer readable medium that can be accessed by a processing device, the computer readable medium storing computer executable instructions or program code for performing the method steps described herein.

It should be recognized that the components illustrated in FIG. 3 are exemplary only, and that it is contemplated that the methods described herein may be implemented by various combinations of hardware, software, firmware, circuitry, and/or processors and associated memory, for example, as well as other components known to those of ordinary skill in the art.

While the methods and system of the present disclosure have been particularly shown and described with reference to specific embodiments, it should be apparent to those skilled in the art that the foregoing is illustrative only and not limiting, having been presented by way of example only. Various changes in form and detail may be made therein without departing from the spirit and scope of the disclosure. Therefore, numerous other embodiments are contemplated as falling within the scope of the present methods and system as defined by the accompanying claims and equivalents thereto.

What is claimed is:

1. A method of sharing and managing ownership of and access to digital media works, the method comprising:
offering for sale in an initial offering, by a processing device, a predetermined number of blocks of a digital media work, each block representing a share of ownership of the digital media work;
providing access, by the processing device, to a user to use the digital media work in response to the user purchasing at least one of the predetermined number of blocks; and
updating, by the processing device, a selling price of the predetermined number of blocks based on a demand for the digital media work.

2. The method of claim 1, wherein updating the selling price includes increasing, by the processing device, the selling price of the predetermined number of blocks remaining for sale in incremental amounts in proportion to a percentage of the predetermined number of blocks sold.

3. The method of claim 1, wherein the digital media work comprises one of a digital song, a digital movie, a digital artwork, a digital photograph, a digital book, and a gaming application.

4. The method of claim 1, further comprising providing the user access, by the processing device, to a plurality of users for offering for sale at least one of the predetermined blocks purchased by the user to the plurality of users, in response to the predetermined number of blocks being sold out in the initial offering.

5. The method of claim 1, wherein the providing access includes providing access to the user to use the digital media via a link.

6. The method of claim 1, further comprising preventing the user from reproducing or downloading the digital media.

7. The method of claim 1, wherein updating the selling price includes increasing, by the processing device, the selling price in proportion to an increase in the frequency of sales of the predetermined number of blocks.

8. A system of sharing and managing ownership of and access to digital media works, the system comprising:
a processing device; and
a storage device for storing instructions that, when executed by the processing device, perform operations comprising:
offering for sale in an initial offering a predetermined number of blocks of a digital media work, each block representing a share of ownership of the digital media work;
providing access to a user to use the digital media work in response to the user purchasing at least one of the predetermined number of blocks; and
updating a selling price of the predetermined number of blocks based on a demand for the digital media work.

9. The system of claim 8, wherein the operation for updating the selling price includes increasing the selling price of the predetermined number of blocks remaining for sale in incremental amounts in proportion to a percentage of the predetermined number of blocks sold.

10. The system of claim 8, wherein the digital media work comprises one of a digital song, a digital movie, a digital book, and a gaming application.

11. The system of claim 8, wherein the operations further comprise providing the user access to a plurality of users for offering for sale at least one of the predetermined blocks purchased by the user to the plurality of users, in response to the predetermined number of blocks being sold out in the initial offering.

12. The system of claim 8, wherein the operation for providing access includes providing access to the user via a link to use the digital media.

13. The system of claim 8, the operations further comprising blocking the user from reproducing or downloading the digital media.

14. The system of claim 8, the operation for updating the selling price including increasing the selling price in proportion to an increase in the frequency of sales of the predetermined number of blocks.

15. A computer readable device storing instructions that, when executed by a processing device, perform operations comprising:
offering for sale in an initial offering a predetermined number of blocks of a digital media work, each block representing a share of ownership of the digital media work;
providing access to a user to use the digital media work in response to the user purchasing at least one of the predetermined number of blocks; and
updating a selling price of the predetermined number of blocks based on a demand for the digital media work.

16. The computer readable device of claim 15, wherein the operations for updating the selling price include increasing the selling price of the predetermined number of blocks remaining for sale in incremental amounts in proportion to a percentage of the predetermined number of blocks sold.

17. The computer readable device of claim 15, wherein the digital media work comprises one of a digital song, a digital movie, a digital book, and a gaming application.

18. The computer readable device of claim 15, wherein the operations further comprise providing the user access to a plurality of users for offering for sale at least one of the predetermined blocks purchased by the user to the plurality of users, in response to the predetermined number of blocks being sold out in the initial offering.

19. The computer readable device of claim 15, wherein the operations for providing access include providing access to the user via a link to use the digital media, the operations further comprising at least one of blocking the user from reproducing the digital media and blocking the user from downloading the digital media.

20. The computer readable device of claim 15, wherein the operation for updating the selling price includes increasing the selling price in proportion to an increase in the frequency of sales of the predetermined number of blocks.
